(19) United States
(12) Patent Application Publication
(10) Pub. No.: US 2024/0336188 A1
(43) Pub. Date: Oct. 10, 2024

(54) AN EMERGENCY NOTIFICATION DEVICE

(71) Applicant: Maryne Roestoff, Groot Brakrivier (ZA)

(72) Inventors: Maryne Roestoff, Groot Brakrivier (ZA); Barend Jacobus Du Plessis, Pretoria (ZA); Andre Louw, Pretoria (ZA)

(21) Appl. No.: 18/578,829

(22) PCT Filed: Jul. 12, 2022
(86) PCT No.: PCT/ZA2022/050030

§ 371 Date: Jan. 12, 2024

(30) Foreign Application Priority Data
Jul. 12, 2021 (ZA) 2021/04838
Nov. 4, 2021 (ZA) 2021/08591

(51) Int. Cl. B60Q 1/52; B60Q 1/00; B60Q 1/30

(52) U.S. Cl. CPC B60Q 1/52; B60Q 1/0076; B60Q 1/30; B60Q 2400/50

(57) ABSTRACT

The emergency notification device (110) includes an emergency sign (112) mountable on a vehicle (not shown), and a revealing means in the form of a switch (not shown) for allowing a user (not shown) within the vehicle (not shown) to reveal the emergency sign (112) to an observer (not shown) outside the vehicle (not shown) so as to notify the observer (not shown) of an emergency in a discreet manner.

### TECHNICAL FIELD

This invention relates to an emergency notification device. In particular, this invention relates to an emergency notification device for notifying observers of an emergency taking place inside a vehicle.

### SUMMARY OF THE INVENTION

According to the invention, there is provided an emergency notification device including:—
an emergency sign mountable on a vehicle; and
a revealing means for allowing a user to reveal the emergency sign to an observer outside the vehicle for notifying the observer of an emergency in a discreet manner.

The emergency sign may include elements of the group including a letter, word, phrase, number, and symbol. The elements, alone or in combination, may be indicative of an emergency. The emergency sign may include words or phrases which may carry out any one or more of the group including inform the observer that an emergency of a particular type is taking place, request assistance from the observer, request the observer to contact emergency services, and the like. The emergency sign may include contact numbers of a call centre or local emergency service, such as the police or an ambulance. More specifically, the emergency sign may include any one or more of the words, phrases or numbers of the group including “Help”, “Emergency”, “Call Police”, “Call 10111”, and the like. The emergency sign may be in the form of flashing light. The flashing light may be configured to flash in a time and duration which would indicate an emergency to the observer. In particular, the flashing light may be configured to flash in a morse code fashion, typically flashing a message requesting assistance, such as an S.O.S. message.

The emergency sign may be mounted on an interior surface of the vehicle whilst being visible to the observer through a window of the vehicle. The emergency sign may be mounted on any of the lights of the vehicle, including indicators, headlights and/or tail lights. The emergency sign may be mounted on the vehicle and orientated to be visible from a rear of the vehicle. The emergency sign may be mounted on a rear portion of the vehicle. The emergency sign may be mounted on the vehicle in a vicinity of a license or number plate of the vehicle. More particularly, the emergency sign may be mounted on a portion of a license plate holding member of the vehicle. The portion of the license plate holding member may be in the form of a frame-like member which may extend from an edge region, preferably an operative peripheral lower edge region, of the license plate holding member. The edge region may be the longer or shorter edge of the license plate holding member. The frame-like member may include a mounting formation for allowing the emergency sign to be mounted thereon, typically via an adhesive or fastening arrangement.

The elements of the sign may be printed on, embossed in, or cut out of a surface of the emergency sign thereby causing the elements to be capable of being viewed. Alternatively, the elements of the emergency sign may be mounted on the surface of the emergency sign wherein the elements may be spaced apart from the emergency sign surface.

The elements of the sign may be defined by an element defining light arrangement. The element defining light arrangement may be in the form of a light capable of deforming into an element. For example, a neon light arrangement may be deformed to display the elements. Alternatively, the element defining light arrangement may include a plurality of lights arranged adjacent one another in such a manner so as to form individual elements. For example, a plurality of lights may be arranged to spell out a word or show a number.

The elements of the sign may be defined by a generally opaque material. The elements may be cut into the generally opaque material. Preferably, the elements may be cut or stamped from the generally opaque material. It is to be appreciated that cutting or stamping the elements from the opaque material leaves element shaped apertures in the opaque material for allowing light to pass therethrough and render the elements easily visible. The opaque material may be manufactured from any suitable synthetic, plastic or metallic material. Preferably, the opaque material may be manufactured from a plastic material. Further preferably, the opaque material may be in the form of vinyl tape, preferably black vinyl tape.

The emergency sign may include a light arrangement for illuminating the elements thereof thereby causing the elements of the emergency sign to be viewed easily, typically in an emergency. The light arrangement may be positioned adjacent the emergency sign and orientated to shine on the emergency sign thereby illuminating the elements thereof. The light arrangement may be positioned behind the elements of the emergency sign for illuminating the elements from behind. It is to be appreciated that light being shone from behind the elements may pass through apertures in an opaque material or may serve as a backlight which may illuminate a space around an element cut from a generally opaque material while leaving a viewing surface of the element darkened thereby allowing the element to be viewable in a negative fashion. The light arrangement may be in the form of any light of the group including an incandescent light, fluorescent light, halogen light, metal halide light, LED (Light Emitting Diode), fluorescent tube, optical cable, side glow fibre optic cable, and neon light. Preferably the light arrangement includes a light having a low power consumption and a compact size. The light arrangement may include an LED or a plurality of LEDs. The light arrangement may be in the form of an LED strip.

The emergency sign may include a base member which is mountable on the vehicle. The base member may be mountable on a license plate holding member of the vehicle. Alternatively, the base member may extend from a license plate holding member of the vehicle, preferably being integrally formed therewith. The base member may have a generally elongate shape, preferably having a generally elongate planar shape. The base member may have a length and width in the ranges of 50 mm to 750 mm and 10 mm to 100 mm, respectively, preferably having a length and width in the regions of 530 mm and 40 mm, respectively. The base member may have a thickness in the range of 1 mm to 10 mm, preferably having a thickness in the region of 3.5 mm. The light arrangement may be mounted on the base member. In particular, the base member may include a receiving formation for receiving the light arrangement therein. The base member may further include receiving zones for receiving wiring of the light arrangement therein. The base member may be manufactured from any suitable synthetic or plastic material, preferably being manufactured from acrylonitrile butadiene styrene (ABS).

The emergency sign may include a light diffusing member for diffusing light emitted by the light arrangement so as to more effectively illuminate the elements of the emergency sign. The light diffusing member may be manufactured from a semi-transparent material. The light diffusing member may have size and/or shape which corresponds to the base member. In particular, the light diffusing member may have a length and width in the ranges of 50 mm to 750 mm and 10 mm to 100 mm, respectively, preferably having a length and width in the regions of 520 mm and 30 mm, respectively. The light diffusing member may have a thickness in the range of 1 mm to 10 mm, preferably having a thickness in the region of 3 mm. The light diffusing member may be manufactured from a methyl methacrylate material. More particularly, the light diffusing member may be manufactured from any one of the group including Perspex™, Plexiglass™, and Plexiglass™ Opal. The light diffusing member may be mounted on the base member, preferably being mounted thereon so as to cover the light arrangement. The light diffusing member may be mounted on the base member via an adhesive. The adhesive may be in the form of an adhesive tape, such as 3M™ VHB™ tape for example.

A colouring member may be provided for colouring light to be emitted from the emergency sign. The colouring member may be in the form of a translucent material. Preferably, the colouring member may be in the form of a piece of translucent vinyl tape, which may have any suitable colour, preferably being generally red, amber, orange, or yellow.

An element concealing member may be provided for concealing elements of the emergency sign during a non-emergency situation. The element concealing member may be configured to conceal the elements of the emergency sign in circumstances when the emergency sign is exposed to direct sunlight which would give the appearance that the elements of the emergency sign are being illuminated. The element concealing member may be manufactured from a semi-transparent material. Preferably, the element concealing member may be manufactured from smoked Plexiglas™. The element concealing member may be secured via an adhesive tape. The element concealing member may have a thickness in the range of 1 mm to 5 mm, preferably having a thickness in the region of 3 mm.

The emergency sign may include a projection apparatus for allowing elements of the emergency sign to be projected onto a surface external to the vehicle. Typically, the projection apparatus may be configured to project elements of the emergency sign onto a road surface for allowing an observer to view said elements. The projection apparatus may be configured to project the elements outside a viewing scope or range of a passenger and/or driver of the vehicle, preferably with or without the use of any rear- or side-view mirrors of the vehicle. It is to be appreciated that this feature would serve to ensure that an intruder is unable to see the projection and will not be alerted to the fact that emergency services will or will have been contacted. The projection apparatus may be remotely configurable for allowing a user to display a custom message which may be dependent on the circumstances, wherein the user of the vehicle may be trapped in the vehicle or the user may be a distance away from the vehicle. The projection apparatus may be connectable to a computing device of the user, such as a smart phone or the like, for allowing the user to type custom messages on the smart phone for remote transmission to the projection apparatus for displaying the custom message. The projection apparatus may be located anywhere on the vehicle, preferably being located in an inconspicuous position.

The revealing means may be configured to allow a user within the vehicle to reveal the emergency sign to an observer outside the vehicle.

The revealing means may be in the form of a cover member mounted displaceably over the emergency sign and a cover displacement means for displacing the cover member between covered and un-covered conditions. In particular, the cover member may be displaceable between a covered condition wherein the cover is positioned over the emergency sign thereby inhibiting viewing of the emergency sign, typically in a non-emergency situation, and an un-covered condition wherein the cover is displaced away from the emergency sign thereby allowing an observer to view the emergency sign.

The revealing means may be in the form of a switch which may be electrically connected between a power source and the light arrangement of the emergency sign. Alternatively, the revealing means may be in the form of a button on a remote-control device. The remote-control device may be in the form of a conventional remote-control, such as a remote controller for a gate or garage door for example. The remote-control device may be in the form of a smart device such as a smart phone, tablet or smart watch. The switch may be configured to allow a user to turn the light arrangement on when faced with an emergency thereby illuminating and revealing the elements of the emergency sign and to turn the light off under normal circumstances. The switch may be in the form of any suitable conventional switch. The switch may be located anywhere within the vehicle. The switch may be concealed or hidden within the vehicle. The switch may be located in the vicinity of a driver or passenger of the vehicle. The switch may be located in a compartment inside the vehicle, such as the glove compartment and the like. The switch may be located in the region of a sun-visor of the vehicle. The switch may be located in the engine compartment of the vehicle. The switch may be located in a boot or trunk of the vehicle. The switch may be located according to the requirements of an owner of the vehicle. A plurality of switches may be located throughout the vehicle for allowing a distressed user under various emergency circumstances to be capable of revealing the emergency sign to an observer in the case of an emergency. The switch may be sized and/or shaped so as to lack visual distinctiveness with respect to an object on which the switch may be mounted. The switch may have a camouflaged appearance with respect to the interior of the vehicle. In particular, the switch may have an appearance designed to blend into the appearance of the object on which it may be mounted in order to reduce its visibility and in so doing, reducing a likelihood of being spotted by an intruder.

A deactivation means may be provided for deactivating a light arrangement of the emergency sign, the light arrangement preferably being electrically operable. The deactivation means may be in the form of an electrical off-switch. The electrical off-switch may be connected, either wired or wirelessly, to the light arrangement. The electrical off-switch may be located remote from the revealing switch. It is to be appreciated that the off-switch being remote from the revealing switch would serve to defer the scenario in which an intruder may simply turn the light off after being turned on. The electrical off-switch may be concealed within the vehicle. The electrical off-switch may be mounted in a concealed location on the outside of the vehicle. Alternatively, the deactivation means may be in the form of a button on a remote-control device. The remote-control device may be in the form of a conventional remote-control, such as a remote controller for a gate or garage door for example. The remote-control device may be in the form of a smart device such as a smart phone, tablet or smart watch. Further alternatively, deactivation of the light arrangement may be achieved only by disconnecting the vehicle battery.

The emergency sign may be in the form of a light or plurality of lights which may define letters, words, phrases, numbers and/or symbols. The lights may be in the form of any light capable of being arranged to define a letter, number, symbol or the like. The lights may be in the form of LED lights, an LED strip or neon lights. Letters, wording, phrases, numbers, and/or symbols of the emergency sign may be defined by the light, preferably a plurality of lights placed alongside each other so as to define the letters, wording, phrases, numbers and/or symbols.

An energising means, typically in the form of a battery, may be provided for energising light arrangements of the emergency sign. The battery may be in the form of a conventional vehicle battery, wherein the light arrangement may be electrically connected thereto. Alternatively, the battery may be in the form of a dedicated battery pack which may be connected to the light arrangement. The dedicated battery pack may be concealed within the vehicle or mounted in a concealed location on an outside of the vehicle. The battery may be in the form of a 12V battery. The battery may include a plurality of smaller batteries connected to each other. In particular, the battery may include 8 AA size batteries.

The emergency notification device may include a communication arrangement for allowing communication with an emergency service for allowing alerting thereof when the emergency sign is revealed by a user in distress. The communication arrangement may include a transmitter for transmitting an emergency signal to the emergency service. A GPS (Global Positioning System) unit may be provided for allowing the relevant emergency service to locate the distressed user. The GPS unit may be mounted in the vehicle or on the emergency sign.

### BRIEF DESCRIPTION OF THE DRAWINGS

An emergency notification device in accordance with the invention will now be described by way of the following, non-limiting examples with reference to the accompanying drawings.

In the drawings:—

FIG. 1 is a photograph showing a part of an emergency notification device in accordance with the present invention, in an inoperative condition;

FIG. 2 is a photograph of the part of the emergency notification device as shown in FIG. 1 in an operative condition wherein an emergency sign is illuminated;

FIG. 3 is a three-dimensional exploded assembly view showing a second embodiment of the emergency notification device in accordance with the present invention; and

FIGS. 4 to 7 are three-dimensional schematics of various parts of the emergency notification device shown in FIG. 3.

### DETAILED DESCRIPTION OF THE INVENTION

Referring now to the drawings, reference numeral 10 refers generally to an emergency notification device in accordance with the present invention.

The emergency notification device 10 includes an emergency sign 12 mountable on a vehicle (not shown), and a revealing means in the form of a switch (not shown) for allowing a user (not shown) within the vehicle (not shown) to reveal the emergency sign 12 to an observer (not shown) outside the vehicle (not shown) so as to notify the observer (not shown) of an emergency in a discreet manner.

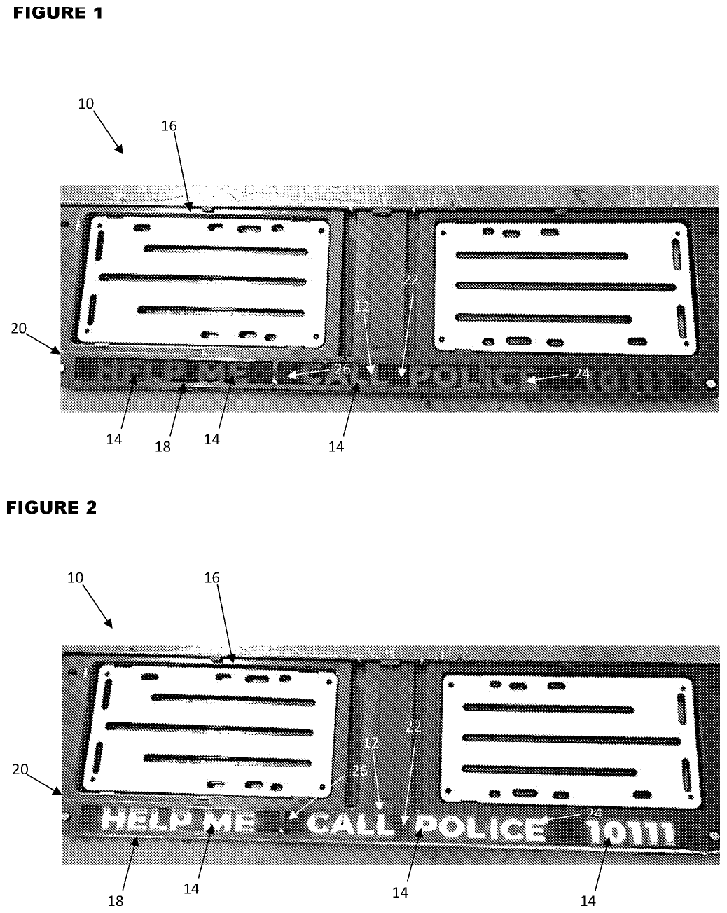

The emergency sign 12 includes elements 14 of the group including a letter, word, phrase, number, and symbol. The elements, alone or in combination, are indicative of an emergency. For the purposes of this specification, and to avoid lengthy repetition, the word element is to be understood as a collective term for letters, words, phrases, numbers and symbols which form part of the emergency sign 12. As shown in the accompanying FIG. 1, the emergency sign 12 includes the phrases: “Help me” and “Call Police” and the number “10111”, which is an emergency contact number for the South African Police Department. Although the phrases shown in FIG. 1 are generic, the phrases could be more specific so as to carry out any one or more of the group including inform the observer (not shown) that an emergency of a particular type is taking place, request assistance from the observer (not shown), request the observer (not shown) to contact emergency services, and the like. The emergency sign 12 can include contact numbers of a call centre, or local emergency service, such as the police, as shown, or an ambulance.

Although not shown in the Figures, the emergency sign 12 can be mounted on an interior surface (not shown) of the vehicle (not shown) whilst still being visible to the observer (not shown) through a window (not shown) of the vehicle (not shown). The emergency sign 12 is mounted on the vehicle (not shown) and orientated to be visible from a rear of the vehicle (not shown). The emergency sign 12 is mounted on a rear portion (not shown) of the vehicle (not shown). The emergency sign 12 is mounted on the vehicle (not shown) in a vicinity of a license or number plate (not shown) of the vehicle (not shown). More particularly, the emergency sign 12 is mounted on a portion of a license plate holding member 16 of the vehicle (not shown). The portion of the license plate holding member 16 is in the form of a frame-like member 18 which extends from an operative peripheral lower edge region 20 of the license plate holding member 16. The edge region 20 is the longer edge of the license plate holding member 16. The frame-like member 18 includes a mounting formation (not shown) for allowing the emergency sign 12 to be mounted thereon, typically via an adhesive (not shown) or fastening arrangement (not shown).

The emergency sign 12 includes a surface 22 on which elements 14 of the emergency sign 12 are viewable. The elements 14 are defined by a semi-transparent material for allowing passage of light therethrough. The semi-transparent material is in the form of glass or plastic, typically being manufactured from a durable plastic material. Referring to FIGS. 1 and 2, the elements 14 of the emergency sign 12 are cut from a piece of black vinyl tape 28, wherein the piece of tape 28 remaining is stuck onto the diffusing member (not shown) so as to allow light from the LED strip (not shown) to exit via the holes defining the elements 14 of the emergency sign 12.

The emergency sign 12 includes a light arrangement (not shown directly) for illuminating the elements 14 thereof thereby causing the elements 14 of the emergency sign 12 to be viewed easily, typically in an emergency. The light arrangement (not shown) is positioned behind the elements 14 of the emergency sign 12 for illuminating the elements 14 from behind. Light being shone from behind is allowed to pass through the elements 14 of a semi-transparent material 24 while being blocked by a generally opaque material 26 surrounding the elements 14 thereby appearing to illuminate the elements 14. Alternatively, and although not shown in the Figures, light being shone from behind may serve as a backlight which may illuminate a space around an element made from a generally opaque material while leaving a viewing surface of the element darkened thereby allowing the element to be viewable in a negative fashion. The light arrangement (not shown) may be in the form of any light of the group including an incandescent light, fluorescent light, halogen light, metal halide light, LED (Light Emitting Diode), fluorescent tube, optical cable, side glow fibre optic, and neon light. Typically, the light arrangement (not shown) includes a light having a low power consumption and a compact size. The light arrangement (not shown) includes an LED or a plurality of LEDs, typically being in the form of an LED strip.

The switch (not shown) is electrically connected between a power source (not shown) and the light arrangement of the emergency sign 12. The switch (not shown) is configured to allow a user (not shown) to turn the light on when faced with an emergency thereby illuminating and revealing the elements 14 of the emergency sign 12 and to turn the light off under normal circumstances. The switch (not shown) is in the form of any suitable conventional electrical switch (not shown). The switch (not shown) is located anywhere within the vehicle (not shown). The switch (not shown) is concealed or hidden within the vehicle (not shown). The switch (not shown) is located in the vicinity of a driver (not shown) or passenger (not shown) of the vehicle (not shown). The switch (not shown) is located in a compartment (not shown) inside the vehicle (not shown), such as the glove compartment (not shown) and the like. The switch (not shown) is located in the region of a sun-visor (not shown) of the vehicle (not shown). The switch (not shown) is located in the engine compartment (not shown) of the vehicle (not shown). The switch (not shown) is located in a boot or trunk (not shown) of the vehicle (not shown). The switch (not shown) is located according to the requirements of an owner (not shown) of the vehicle (not shown). A plurality of switches (not shown) are located throughout the vehicle (not shown) for allowing a distressed user (not shown) under various emergency circumstances to be capable of revealing the emergency sign 12 to an observer (not shown) in the case of an emergency. The switch (not shown) is sized and shaped so as to lack visual distinctiveness with respect to an object (not shown) on which the switch (not shown) is mounted. The switch (not shown) has a camouflaged appearance with respect to the interior of the vehicle (not shown). In particular, the switch (not shown) has an appearance designed to blend into the appearance of the object (not shown) on which it is mounted in order to reduce its visibility and in so doing, reducing a likelihood of being spotted by an intruder (not shown).

An energising means (not shown), typically in the form of a battery, is provided for energising light arrangements of the emergency sign 12. The battery (not shown) can be in the form of a conventional vehicle battery (not shown), wherein the light arrangement is electrically connected thereto. Alternatively, the battery (not shown) can be in the form of a dedicated battery pack which is connected to the light arrangement. The dedicated battery pack is concealed within the vehicle or mounted in a concealed location on an outside of the vehicle. The battery can be in the form of a 12V battery (not shown). The battery (not shown) includes a plurality of smaller batteries (not shown) connected to each other. In particular, the battery (not shown) includes 8 AA size batteries (not shown).

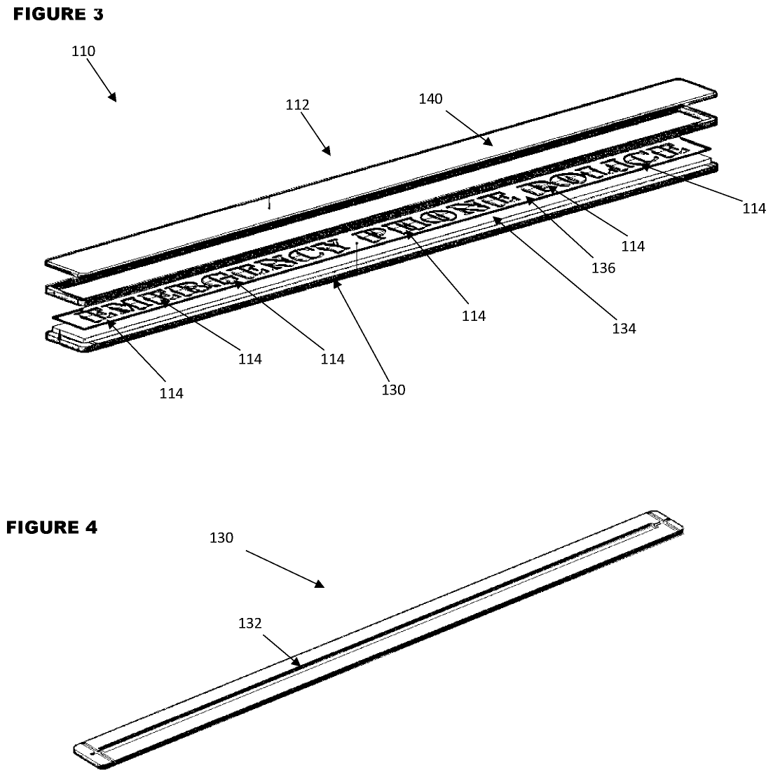

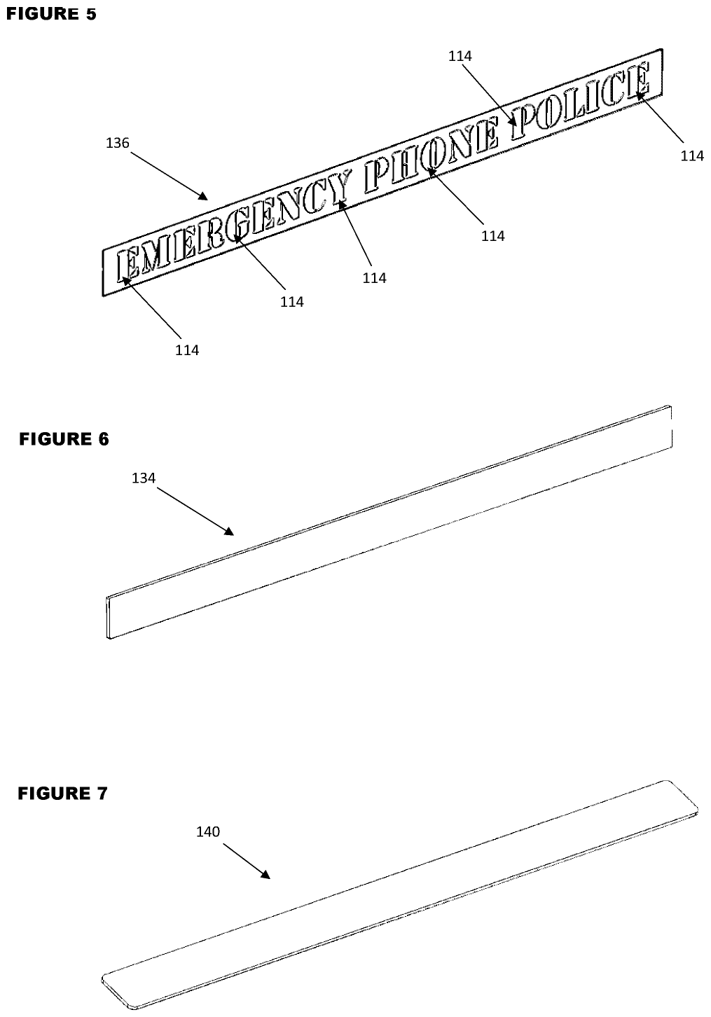

Referring now to FIGS. 3 to 7, reference numeral 110 refers generally to a second embodiment of the emergency notification device in accordance with the present invention.

In this embodiment, the emergency notification device 110 includes an emergency sign 112 having a base member 130. The base member 130 is mountable on a vehicle (not shown). More particularly, the base member 130 is mountable on the vehicle (not shown) in the region of a license plate (not shown) thereof. The base member 130 has a generally elongate shape, typically having a generally elongate planar shape. The base member 130 has a length and width in the ranges of 50 mm to 750 mm and 10 mm to 100 mm, respectively, typically having a length and width in the regions of 530 mm and 40 mm, respectively. The base member 130 has a thickness in the range of 1 mm to 10 mm, typically having a thickness in the region of 3.5 mm. The base member 130 is manufactured from any suitable synthetic, plastic or metallic material, typically being manufactured from acrylonitrile butadiene styrene (ABS).

A light arrangement (not shown), in the form of an LED strip (not shown), is mounted on the base member 130, typically being received within a receiving formation 132 defined in the base member 130.

The emergency sign 112 includes a light diffusing member 134 for diffusing light emitted by the light arrangement (not shown) so as to more effectively illuminate elements 114 of the emergency sign 112. The light diffusing member 134 is manufactured from a semi-transparent material. The light diffusing member 134 has a size and shape which corresponds to the base member 130. In particular, the light diffusing member 134 has a length and width in the ranges of 50 mm to 750 mm and 10 mm to 100 mm, respectively, typically having a length and width in the regions of 520 mm and 30 mm, respectively. The light diffusing member 134 has a thickness in the range of 1 mm to 10 mm, typically having a thickness in the region of 3 mm. The light diffusing member 134 is manufactured from a methyl methacrylate material. More particularly, the light diffusing member 134 is manufactured from any one of the group including Perspex™, Plexiglass™, and Plexiglass™ Opal. The light diffusing member 134 is mounted on the base member 130, typically being mounted thereon so as to cover the light arrangement (not shown). The light diffusing member 134 is mounted on the base member 130 via an adhesive (not shown). The adhesive (not shown) is in the form of an adhesive tape (not shown), such as 3M™ VHB™ tape for example.

The elements 114 of the emergency sign 112 are defined by a generally opaque material, typically a plate-like opaque member 136 as shown in Figures X. The elements 114 are cut or stamped from the opaque member 136. It is to be appreciated that cutting or stamping the elements 114 from the opaque member 136 leaves element shaped apertures in the opaque member 136 for allowing light to pass therethrough and render the elements 114 easily visible. The opaque member 136 is manufactured from any suitable synthetic, plastic or metallic material, typically being manufactured from a plastic material.

An element concealing member 140 is provided for concealing elements 114 of the emergency sign 112 during a non-emergency situation. The element concealing member 140 is configured to conceal the elements 114 of the emergency sign 112 in circumstances when the emergency sign 112 is exposed to direct sunlight which would give the appearance that the elements 114 of the emergency sign 112 are being illuminated. The element concealing member 140 is manufactured from a semi-transparent material, typically being manufactured from smoked Plexiglas™. The element concealing member 140 secured via an adhesive tape (not shown). The element concealing member 140 has a thickness in the range of 1 mm to 5 mm, typically having a thickness in the region of 3 mm.

It is, of course, to be appreciated that the emergency notification device in accordance with the invention is not limited to the precise constructional and functional details as hereinbefore described with reference to the accompanying drawings and which is varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

The inventor believes that the emergency notification device in accordance with the present invention is advantageous in that it allows a user experiencing an emergency situation inside a vehicle, such as an attempted hijacking, hijacking, abuse, kidnapping, and the like, to alert and notify an observer in an inconspicuous manner.

1. An emergency notification device including:—
an emergency sign mountable on a vehicle;
a revealing means for allowing a user to reveal the emergency sign to an observer outside the vehicle for notifying the observer of an emergency in a discreet manner; and
a deactivation means, in the form of an electrical off-switch, for deactivating a light arrangement of the emergency sign.

2.-5. (canceled)

6. An emergency notification device as claimed in claim 1 wherein the emergency sign is mounted on any of the lights of the vehicle.

7. An emergency notification device as claimed in claim 1 wherein the emergency sign is mounted on the vehicle and orientated to be visible from a rear of the vehicle.

8.-20. (canceled)

21. An emergency notification device as claimed in claim 1 wherein the emergency sign includes a light diffusing member for diffusing light emitted by the light arrangement so as to more effectively illuminate elements of the emergency sign.

22.-24. (canceled)

25. An emergency notification device as claimed in claim 1 wherein an element concealing member is provided for concealing elements of the emergency sign during a non-emergency situation.

26. An emergency notification device as claimed in claim 5 wherein the element concealing member is configured to conceal the elements of the emergency sign in circumstances when the emergency sign is exposed to direct sunlight which would give the appearance that the elements of the emergency sign are being illuminated.

27. (canceled)

28. An emergency notification device as claimed in claim 1 wherein the emergency sign includes a projection apparatus for allowing elements of the emergency sign to be projected onto a surface external to the vehicle.

29. (canceled)

30. An emergency notification device as claimed in claim 1 wherein the revealing means is in the form of a switch which is electrically connected between a power source and the light arrangement of the emergency sign.

31. An emergency notification device as claimed in claim 1 wherein the revealing means is in the form of a button on a remote-control device.

32. An emergency notification device as claimed in claim 9 wherein the remote-control device is in the form of a smart device such as a smart phone, tablet or smart watch.

33. An emergency notification device as claimed in claim 8 wherein the switch is concealed or hidden within the vehicle.

34. An emergency notification device as claimed in claim 8 wherein the switch is located in the vicinity of a driver or passenger of the vehicle.

35. An emergency notification device as claimed in claim 8 wherein the switch is located in a boot or trunk of the vehicle.

36. An emergency notification device as claimed in claim 8 wherein a plurality of switches are located throughout the vehicle for allowing a distressed user under various emergency circumstances to be capable of revealing the emergency sign to an observer in the case of an emergency.

37. An emergency notification device as claimed in claim 7 wherein the switch is sized and shaped so as to lack visual distinctiveness with respect to an object on which the switch is mounted.

38. An emergency notification device as claimed in claim 8 wherein the switch has a camouflaged appearance with respect to the interior of the vehicle.

39.-40. (canceled)

41. An emergency notification device as claimed in claim 1 wherein the electrical off-switch is located remote from the revealing switch.

42.-44. (canceled)

45. An emergency notification device as claimed in claim 1 wherein the emergency notification device includes a communication arrangement for allowing communication with an emergency service for allowing alerting thereof when the emergency sign is revealed by a user in distress.

46.-48. (canceled)

49. An emergency notification device including:—
an emergency sign mountable on a vehicle; and
a revealing means, in the form of a button on a remote-control device, for allowing a user to reveal the emergency sign to an observer outside the vehicle for notifying the observer of an emergency in a discrete manner.

50. An emergency notification device including:—
an emergency sign mountable on a vehicle;
a revealing means for allowing a user to reveal the emergency sign to an observer outside the vehicle for notifying the observer of an emergency in a discrete manner;
an element concealing member for concealing elements of the emergency sign during a non-emergency situation;
wherein the element concealing member is configured to conceal the elements of the emergency sign in circumstances when the emergency sign is exposed to direct sunlight which would give the appearance that the elements of the emergency sign are being illuminate.
